(19) United States
(12) Patent Application Publication
(10) Pub. No.: US 2008/0042387 A1
(43) Pub. Date: Feb. 21, 2008

(54) Single-handed lifting skateboard

(76) Inventor: Joseph John Lesko, Huntington Beach, CA (US)

Correspondence Address: STETINA BRUNDA GARRED & BRUCKER, 75 ENTERPRISE, SUITE 250, ALISO VIEJO, CA, 92656, US

(21) Appl. No.: 11/503,646

(22) Filed: Aug. 14, 2006

(51) Int. Cl. B62M 1/00

(52) U.S. Cl. 280/87.042

(57) ABSTRACT

In summary, the present invention provides a skateboard body, attachable to a plurality of wheel assemblies. The skateboard body in accordance with the present invention comprises a support platform for supporting a user, the platform being engagable to the wheel assemblies, wherein the platform includes at least one gripping aperture extending through the platform for receiving the user's hand, allowing the user to lift and transport the skateboard body. The present invention also provides a skateboard assembly having a hand engagable support platform for single handed lifting. The skateboard in accordance with the present invention comprises a support platform for supporting a user, a plurality of wheel assemblies engaged to the platform; and at least one gripping aperture extending through the platform for receiving the user's hand, allowing the user to lift and transport the skateboard assembly.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

Skateboarding is one of the most popular recreational sports among young adults. It is also an essential mode of transportation for many. A skateboard is relatively inexpensive to own, and that is usually all one needs to get started. A skateboard is made of a long, oval shaped support platform made of wood, fiberglass or other synthetic material. The support platform, or sometimes referred to as the deck, forms the body of the skateboard and provides footing for a skateboarder. There are generally two sets of wheel assemblies attached to the bottom of the support platform through two metal connection mechanism called trucks. The skateboarder moves the skateboard forward by having one foot on the support platform with another foot pressing against the ground to generate momentum. Once the skateboard starts moving, the skateboarder then lifts the foot on the ground onto the support platform and allows the skateboard to carry him or her forward. The rear end of the board usually comprises an upwardly curved portion so that the skateboarder can lift the front of the skateboard by applying weight to the upwardly curved portion. Lifting up the front of the skateboard allows the skateboarder to jump or perform a sharp turn.

Often a skateboarder will need to pick up the skateboard to avoid an obstacle, to cross an uneven surface or to reposition himself or herself on a course. Conventional approaches of carrying the skateboard involve holding the skateboard vertically by an end with the skateboarder's fingers, or carrying the skateboard sideways against the waist with one or both arms. However, either approach poses problems for the skateboarder. Holding the skateboard by its end is convenient because the skateboarder does not need to bend down and pick up the skateboard. He or she can simply step on one end of the skateboard and bounce the other end into his or her hand. However, holding the skateboard in a vertical position is difficult when the skateboard is heavy, as the friction and pressure between the fingers of the skateboarder do not produce enough strength to securely hold the skateboard's weight. Such risk of slippage is especially great among young children, who make up a large percentage of the skateboarding population. In addition, the discomfort associated with the vertical hold also prevents the skateboarder from carrying the skateboard over an extended period of time.

The skateboarder can also bend down, pick up the skateboard and carry the skateboard sideways with one or both arms against the his or her waist. However, carrying the skateboard sideways increases the risk of having an end of the skateboard running into an object or a person, causing damage or injury. Such risks are especially great when the weight of the skateboard is not balanced. The long length and heavy weight of the skateboard makes it difficult to firmly hold onto the skateboard even with two arms around it, especially for young children. Furthermore, picking up the skateboard sideways requires the skateboarder to bend down and pick up the skateboard, a burdensome task if being done repetitively.

As such, there is a need in the art for a skateboard that can be single-handedly lifted up and carried around while having a firm and balanced grip on the skateboard, reducing the chance of the skateboard slipping through the fingers or running into an object or a person.

### SUMMARY OF THE INVENTION

To minimize the limitations in the prior art, and to minimize other limitation that will become apparent upon reading and understanding the present specification, the present invention provides a skateboard body, attachable to a plurality of wheel assemblies. The skateboard body in accordance with the present invention comprises a support platform for supporting a user, the platform being engagable to the wheel assemblies, wherein the platform includes at least one gripping aperture extending through the platform for receiving the user's hand, allowing the user to lift and transport the skateboard body.

According to various embodiments, the gripping aperture may define a rippled finger receiving aperture edge portion. The gripping aperture may define an oval shape. The support platform may further comprise an insert, removably disposed within the gripping aperture, the insert being configured to substantially occupy the gripping aperture. The insert may include a hollow core for providing storage space. The skateboard body may further comprise an electronic signal transmitter disposed within the insert. The electronic signal transmitter may communicate information representative of the location of the skateboard body. The electronic signal transmitter may communicate information representative of the identification of the skateboard body. The support platform may further comprise a handle. The support platform may be formed of a resilient material.

The present invention also provides a skateboard assembly having a hand engagable support platform for single handed lifting. The skateboard in accordance with the present invention comprises a support platform for supporting a user, a plurality of wheel assemblies engaged to the platform; and at least one gripping aperture extending through the platform for receiving the user's hand, allowing the user to lift and transport the skateboard assembly.

According to various embodiments, the gripping aperture may define a rippled finger receiving aperture edge portion. The gripping aperture may define an oval shape. The support platform may further comprise an insert, removably disposed within the aperture, the insert being configured to substantially occupy the gripping aperture. The insert may further include a hollow core for providing storage space. The skateboard assembly may further comprise an electronic signal transmitter disposed within the insert. The electronic signal transmitter may communicate information representative of a location of the skateboard assembly. The electronic signal transmitter may communicate information representative of an identification of the skateboard assembly. The support platform may further comprise a handle. The support platform may be formed of a resilient material.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 depicts a top view of a skateboard body of the present invention with four gripping apertures, with each defining a rippled finger receiving aperture edge portion;

FIG. 2 depicts a full view of a skateboard assembly of the present invention with four gripping apertures, each defining an oval shape;

FIG. 3 depicts a skateboarder carrying a skateboard assembly of the present invention in a vertical position, holding the skateboard assembly by one of its ends.

FIG. 4 depicts a hand carrying a skateboard assembly of the present invention, holding the skateboard assembly by one of its sides.

FIG. 5 depicts a bottom view of a skateboard assembly of the present invention with two wheel assemblies.

FIG. 6 depicts a partial view of a skateboard assembly of the present invention with three apertures, each substantially occupied with an insert.

FIG. 7 depicts a full view of an insert with a hollow core.

FIG. 7A depicts a cut-away view of an insert with a hollow core.

FIG. 8 depicts a view of an insert with an electronic signal transmitter.

FIG. 9 depicts a skateboard assembly with a handle removably engaged to the end of the skateboard body.

FIG. 10 depicts a skateboard with a handle removably attached to the side of the skateboard body.

FIG. 11 depicts a cross-sectional view of the skateboard body showing a handle removably attached thereto.

### DETAILED DESCRIPTION OF THE PREFERRED EMBODIMENT

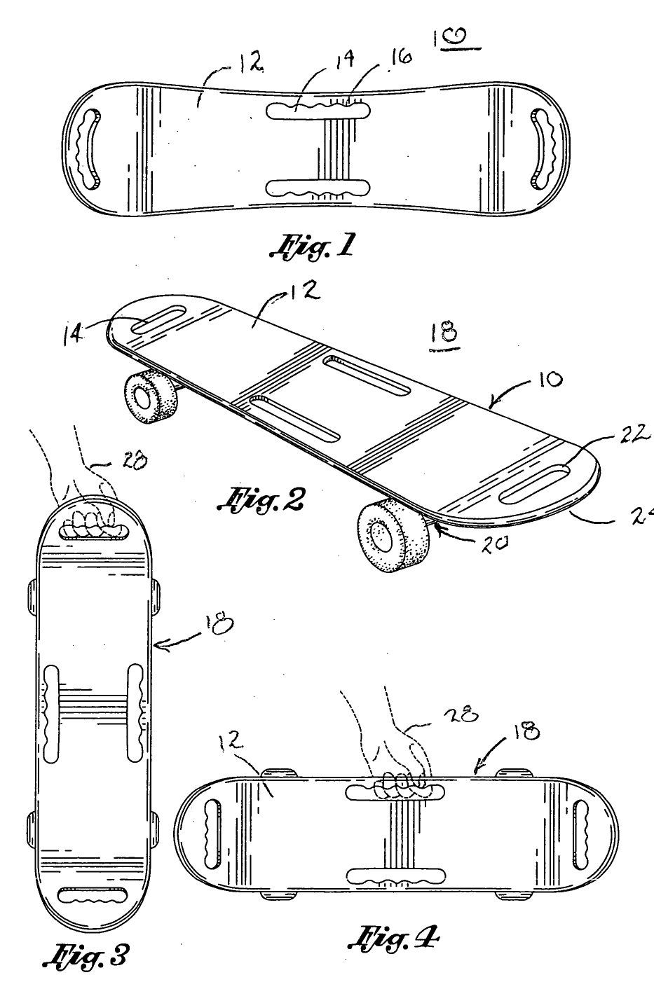

Referring now to FIG. 1, there is depicted a top view of a skateboard body 10 of the present invention (details of which are discussed below and shown in additional figures). The skateboard body 10 is shown with a support platform 12, the support platform 12 being engagable to a plurality of wheel assemblies. The support platform 12 is also shown with four gripping apertures 14 located on the two sides and two ends of the support platform 12, with each of the gripping aperture 14 defining a rippled finger receiving aperture edge portion 16.

The support platform 12, or sometimes referred to as the deck, provides footing for a skateboarder. The support platform 12 is generally made out of wood, Kevlar or fiberglass, but can also be formed of any other resilient material. The support platform 12 is normally 7½ to 8 inches wide and 28 to 32½ inches long. The wider the support platform 12, the more control and stability the skateboarder will have over with the movement of the skateboard body. The rippled finger receiving aperture edge portion 16 of the support platform 12 provide a firm and comfortable grip for carrying the support platform 12. By allowing the fingers of the skateboarder to snuggly fit into one of the curvatures on the rippled finger receiving aperture edge portions 24, the user can single-handedly carry the skateboard body 10 with ease. The grip also produces less fatigue when its user carries the skateboard body 10 over a long period of time.

Referring now to FIG. 2, there is depicted a full view of a skateboard assembly 18 of the present invention (details of which are discussed below and shown in additional figures). The skateboard assembly 18 is shown with a support platform 12, two wheel assemblies 20 engaged to the bottom of the skateboard assembly 18, and four gripping apertures 14.

The gripping apertures 14 in this figure define oval shapes 22. However, the shapes of the gripping apertures 14 may be made into any other shapes depending on the user's preference. The gripping apertures 14 may each have a different shape, and the gripping apertures 14 may have shapes that uniquely identify the skateboard assembly 18 for its user.

The skateboard assembly 18 is also shown with the support platform 12 defining one upwardly curved end portion 24. Serving as a leverage point, the upwardly curved end portion 24 allows a user to lift up the opposite end portion of the skateboard 18 by applying weight onto the upwardly curved end portion 24. The user may also perform jumps and sharp turns when more force is being applied to the upwardly curved end portion 24.

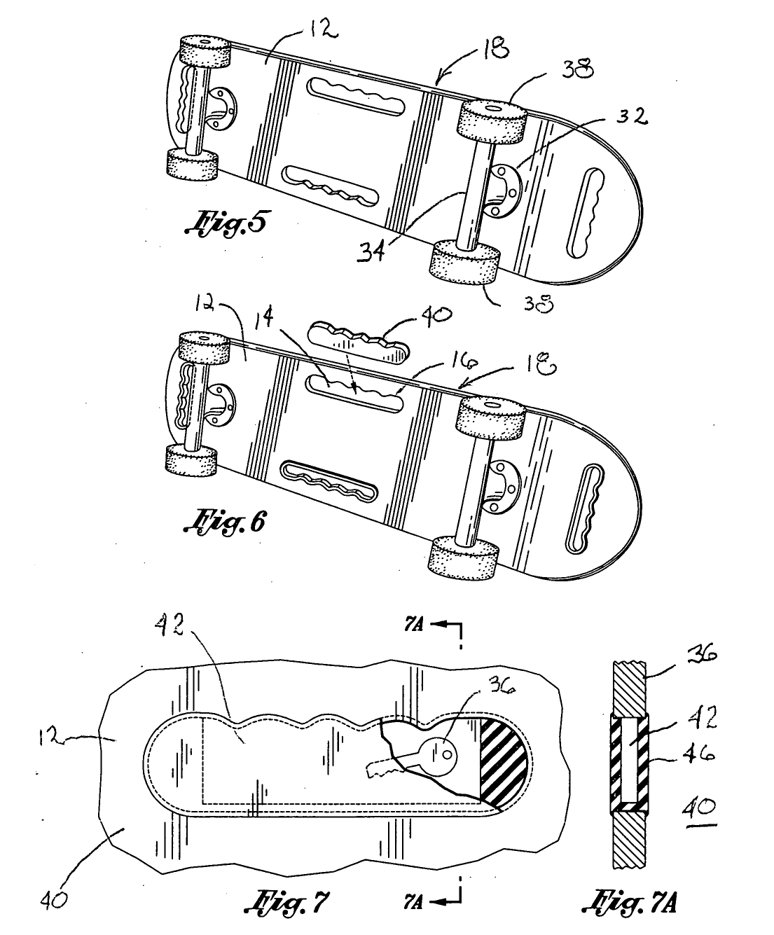

Referring now to FIG. 3, there is depicted a hand 28 carrying the skateboard assembly 18 in a vertical position. The skateboard assembly 18 in the figure has four gripping apertures 14, with each gripping aperture 14 defines a rippled finger receiving aperture edge portion 16.

The gripping apertures 14 provide the single-handed carrying feature of the skateboard assembly 18. Lifting and carrying the skateboard assembly 18 around is a necessary task for a skateboarder. The skateboarder may need to carry the skateboard assembly 18 to go up the stairs, to cross an uneven terrain, to avoid a pedestrian, or to reposition himself or herself on a course for a run. Conventional approaches of carrying the skateboard assembly 18 involve either holding the skateboard assembly 18 in a vertical position by one of its end with the skateboarder's fingers, or carrying the skateboard assembly 18 sideways against the waist with one or both arms. However, either approach poses problems for the skateboarder. Holding the skateboard assembly 18 in a vertical position is a popular approach because the skateboarder does not need to bend down and lift up the skateboard assembly 18. The skateboarder may instead step on one end of the skateboard assembly 18 and bounce the other end into his hand, a neat and convenient move. However carrying the skateboard in a vertical position can be difficult when the skateboard assembly 18 is heavy, as the friction and pressure between the fingers of the skateboarder do not produce enough strength to securely hold onto the skateboard assembly 18. Such risk of slippage is especially great among young children, who make up a large percentage of the skateboarding population. Furthermore, the discomfort associated with the vertical holding position prevents the skateboarder from carrying the skateboard over an extended period of time.

The skateboarder can also bend down, pick up the skateboard assembly 18 and carry the skateboard assembly 18 sideways with one or both arms around it. However, carrying the skateboard assembly 18 sideways increases the risk of having one end of the skateboard assembly 18 running into an object or a person, causing damage or injury. The long length and heavy weight of the skateboard assembly 18 make it difficult for the skateboard to have a balanced hold onto the skateboard even with both arms, especially for young children. In addition, picking up the skateboard assembly 18 sideways requires the skateboarder to bend down, a burdensome task it has to be done over and over again.

The gripping apertures 14 provides the skateboarder a firm and comfortable grip of the skateboard assembly 18 and avoids the problems in the prior art skateboards. The skateboard assembly 18 may be single handedly lifted up and transported through the gripping aperture 14 and reduces the chance of slippage. The gripping apertures 14 acts like a suitcase handle and provide a comfortable and less fatigue hold of the skateboard assembly 18. The gripping apertures 14 may in addition be calculated to locate at a point of the skateboard assembly 18 for balancing the weight of the skateboard assembly 18.

Referring now to FIG. 4, there is depicted a hand 28 carrying the skateboard assembly 18 in a horizontal position. The skateboarder can comfortably use his fingers to firmly hold onto the skateboard assembly 18 through the gripping aperture 14 at a side of the skateboard assembly 18.

Referring now to FIG. 5, there is depicted a bottom view of the skateboard assembly 18 with two wheel assemblies 20 attached to the support platform 12. Each wheel assembly 20 comprises a base plate 32, a hangar 34 and a plurality of wheels 38. The base plate 32 attaches the hanger 34 to the support platform 12. The hangar 34 attaches the plurality of wheels 38 to the base plate 32. The wheel assemblies 20 allow a user to steer the skateboard assembly 18 in the desired direction without lifting the front wheels of the skateboard assembly 18.

The wheels 38 are typically made of polyurethane, and ranges from 50-80 mm in diameter. Having larger wheels 38 increases the flexibility of the skateboard 10 to maneuver through uneven ground.

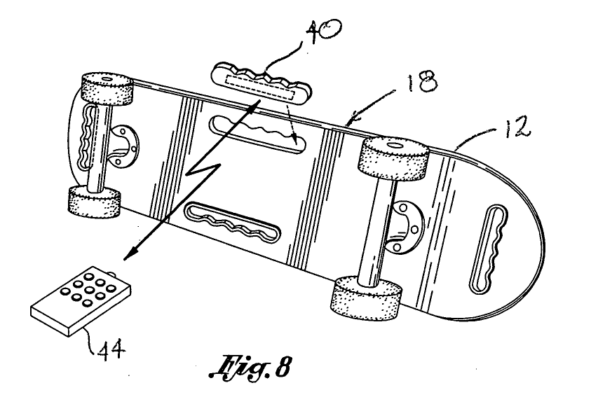

Referring now to FIG. 6, there is depicted partial view of a skateboard assembly 18 with one wheel assembly 20 and three gripping apertures 14, each occupied with an insert 40. The insert 40 provides a filling for the gripping apertures 14 in case a user does not wish to leave the gripping apertures 14 exposed. Such circumstances may arise when the user wishes to increase the weight of the skateboard assembly 18, or for pure aesthetic reasons.

Referring now to FIG. 7, there is depicted a cut-away view of an insert 40 with a hollow core 42. The hollow core 42 opens up on the side of the rippled finger receiving aperture edge portion 16. The hollow core 42 may serve as a storage space for keys 36, ID cards, cash or other items that will fit inside. Leaving personal items in pockets during a run increases the chance of having them lost or stolen, especially if the skateboarder is performing flips and turns with a skateboard. Having a storage space on the support platform 12 allows the user to have a safe place to keep these items.

The dark shaded area shows a material 46 of the insert 40, and the material 46 may be different than a material of the support platform 12. The material 46 may be rubber, plastic or other resilient material.

Referring now to FIG. 7A, there is depicted a cross-sectional view of an insert 40 with a hollow core 42, which is represented by the empty space between the dark shaded area. The cross section view is taken in between two points marked as 7A on FIG. 7.

Referring now to FIG. 8, there is depicted an insert 40 with an electronic signal transmitter 44, such as a RFID tag embedded inside. The electronic signal transmitter 44 may communicate identification and locational information of the skateboard assembly 18 to its owner or others, for example, parents. Such feature is useful in a store or warehouse setting where large number of skateboards is kept, to keep track of a particular skateboard, to locate a stolen skateboard, or to locate a user. The electronic signal transmitter 44 may also be replaced by simply changing the insert 40, in case it is broken.

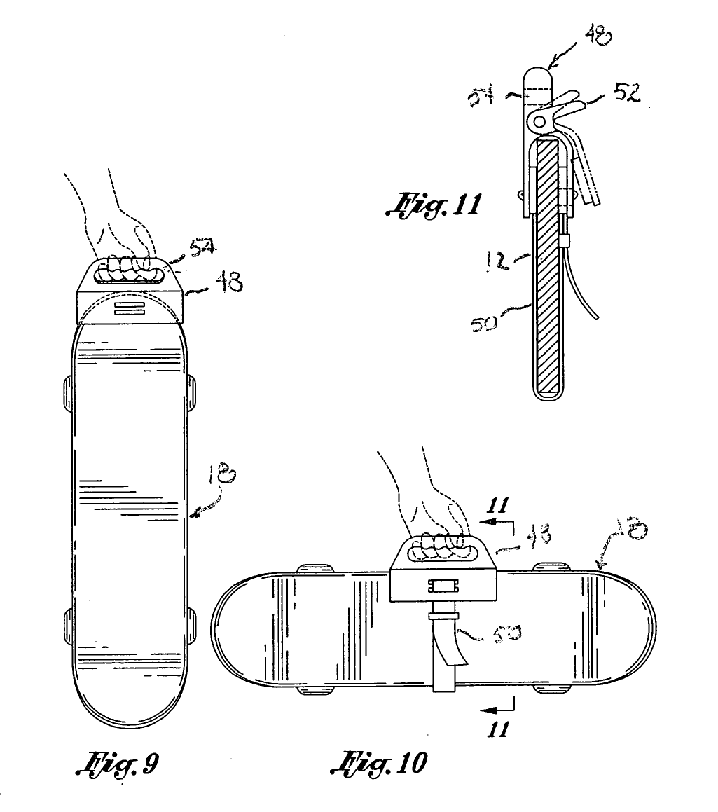

Referring now to FIG. 9, there is depicted a view of a skateboard assembly 18 with a handle 48 attached at a first end of the skateboard assembly. FIG. 10 illustrates a skateboard assembly 18 with the handle 48 attached along a side of the skateboard assembly. FIG. 11 depicts a cross-sectional view of a handle 48 engaged to the skateboard support platform 12. In the presently preferred embodiment the handle 48 incorporates a locking lever 52 which engages strap 50, to maintain the handle in engagement with the skateboard support platform 12. The locking lever 52 operates to allow loosening or tightening of the strap 50 about the support platform 12.

In use, a user may engage a hand through aperture 54, formed in handle 48, to lift and carry the skateboard. The handle can be secured to different portions of the skateboard, as a user may desire.

As will be apparent to those of ordinary skill in the art, various alternate configurations of handle 48 can be implemented within the broader aspects of the invention. In some implementations, the handle may be permanently secured to the skateboard assembly at location that may be convenient for use, without interfering with the functionality of the skateboard. The handle assembly may be used as an alternate to the apertures illustrated and described in connection with FIGS. 1-8, or may be used in conjunction with such apertures as desired.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A skateboard body, attachable to a plurality of wheel assemblies, the skateboard body comprising:
a support platform for supporting a user, the platform being engagable to the wheel assemblies, wherein the platform includes at least one gripping aperture extending through the platform for receiving the user's hand, allowing the user to lift and transport the skateboard body.

2. The skateboard body of claim 1, wherein the gripping aperture defines a rippled finger receiving aperture edge portion.

3. The skateboard body of claim 1, wherein the gripping aperture defines an oval shape.

4. The skateboard body of claim 3, wherein the support platform further comprises an insert, removably disposed within the gripping aperture, the insert being configured to substantially occupy the gripping aperture.

5. The skateboard body of claim 4, wherein the insert includes a hollow core for providing storage space.

6. The skateboard body of claim 4 further comprising an electronic signal transmitter disposed within the insert.

7. The skateboard body of claim 6, wherein the electronic signal transmitter communicates information representative of the location of the skateboard body.

8. The skateboard body of claim 6, wherein the electronic signal transmitter communicates information representative of the identification of the skateboard body.

9. The skateboard body of claim 1, wherein the support platform further comprises a handle.

10. The skateboard body of claim 1, wherein the support platform is formed of a resilient material.

11. A skateboard assembly having a hand engagable support platform for single handed lifting, the skateboard assembly comprising:
a support platform for supporting a user;
a plurality of wheel assemblies engaged to the platform; and
at least one gripping aperture extending through the platform for receiving the user's hand, allowing the user to lift and transport the skateboard assembly.

12. The skateboard assembly of claim 11, wherein the gripping aperture defines a rippled finger receiving aperture edge portion.

13. The skateboard assembly of claim 11, wherein the gripping aperture defines an oval shape.

14. The skateboard assembly of claim 13, wherein the support platform further comprises an insert, removably disposed within the aperture, the insert being configured to substantially occupy the gripping aperture.

15. The skateboard assembly of claim 14, wherein the insert includes a hollow core for providing storage space.

16. The skateboard assembly of claim 14 further comprising an electronic signal transmitter disposed within the insert.

17. The skateboard assembly of claim 16, wherein the electronic signal transmitter communicates information representative of a location of the skateboard assembly.

18. The skateboard assembly of claim 16, wherein the electronic signal transmitter communicates information representative of an identification of the skateboard assembly.

19. The skateboard assembly of claim 11, wherein the support platform further comprises a handle.

20. The skateboard assembly of claim 11, wherein the support platform is formed of a resilient material.

21. The skateboard assembly of claim 11 further comprising a handle detachably engaged to the support platform.
